(19) United States
(12) Patent Application Publication
(10) Pub. No.: US 2013/0272412 A1
(43) Pub. Date: Oct. 17, 2013

(54) COMMON MOTION INFORMATION CANDIDATE LIST CONSTRUCTION PROCESS

(71) Applicant: QUALCOMM INCORPORATED, San Diego, CA (US)

(72) Inventors: Vadim Seregin, San Diego, CA (US); Xianglin Wang, San Diego, CA (US); Marta Karczewicz, San Diego, CA (US)

(73) Assignee: QUALCOMM Incorporated, San Diego, CA (US)

(21) Appl. No.: 13/861,294

(22) Filed: Apr. 11, 2013

Related U.S. Application Data
(60) Provisional application No. 61/623,498, filed on Apr. 12, 2012.

(51) Int. Cl. H04N 7/34

(52) U.S. Cl. CPC H04N 19/00763
USPC 375/240.16

(57) ABSTRACT

In one example, an apparatus for coding video data comprises a video coder configured to generate first and second lists of motion information candidates, respectively, for first and second video block using a common list construction process, wherein the common list construction process is common to at least a first motion information prediction mode and a second motion information prediction mode. The video coder is further configured to code the first video block using the first motion information prediction mode based on a first motion information candidate selected from the first list, and code the second video block using the second motion information prediction mode based on a second motion information candidate selected from the second list.

This application claims the benefit of U.S. Provisional Application Ser. No. 61/623,498, filed Apr. 12, 2012, the entire content of which is incorporated herein by reference.

### TECHNICAL FIELD

This disclosure relates to video coding and, more particularly, to motion information (e.g., motion vector) prediction for video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for constructing motion information candidate lists for motion information prediction, e.g., motion vector prediction (MVP), for a merge mode or advanced motion vector prediction (AMVP) mode, as examples. In particular, the present disclosure describes techniques whereby a plurality of motion information prediction modes use a common motion information candidate list construction process. The common motion information candidate list construction process may include one or more of a common maximum number of motion information candidates for the motion information candidate list, a common scan order for consideration of motion information of neighboring blocks, common criteria for inclusion of motion information of neighboring blocks as a motion information candidate in the motion information candidate list, and a common process for pruning the motion information candidate list. The use of a common motion information candidate list construction process for multiple motion information prediction modes may result in reduced codec complexity relative to use of separate processes for each mode, which may provide one or more benefits, such as a reduction in processing resource consumption and/or a reduction in battery consumption. The use of a common motion information candidate list construction process for multiple motion information prediction modes may also provide for greater unification between the motion information prediction modes.

In some examples, one of the motion information prediction modes uses the motion information list construction process of the other motion information prediction mode instead of its own motion information candidate list construction process. For example, in the AMVP mode, the AMVP motion information candidate list construction process may be replaced by the merge mode motion information candidate list construction process. In such examples, both the merge mode and the AMVP mode may use the merge mode motion information candidate list construction process. For example, to implement an AMVP mode, a video coder may construct a merge mode motion information candidate list according to merge mode list construction process, and then identify candidates from the merge mode list for inclusion in an AMVP mode motion information candidate list, or use the merge mode motion information candidate list directly for coding the video block according to the AMVP mode.

In one example, a method of decoding video data comprises generating a first list of motion information candidates for a first video block using a common list construction process, wherein each of the motion information candidates in the first list has at least one of an associated motion vector or an associated reference picture index, and the common list construction process is common to at least a first motion information prediction mode and a second motion information prediction mode. The method further comprises decoding the first video block using the first motion information prediction mode based on a first motion information candidate selected from the first list. The method further comprises generating a second list of motion information candidates for a second video block using the common list construction process, wherein each motion information candidate in the second list has at least one of an associated motion vector or an associated reference picture index, and decoding the second video block using the second motion information prediction mode based on a second motion information candidate selected from the second list.

In another example, a method of encoding video data comprises generating a first list of motion information candidates for a first video block using a common list construction process, wherein each of the motion information candidates in the first list has at least one of an associated motion vector or an associated reference picture index, and the common list construction process is common to at least a first motion information prediction mode and a second motion information prediction mode. The method further comprises encoding the first video block using the first motion information prediction mode based on a first motion information candidate selected from the first list. The method further comprises generating a second list of motion information candidates for a second video block using the common list construction process, wherein each motion information candidate in the second list has at least one of an associated motion vector or an associated reference picture index, and encoding the second video block using the second motion information prediction mode based on a second motion information candidate selected from the second list.

In another example, an apparatus for coding video data comprises a video coder configured to generate a first list of motion information candidates for a first video block using a common list construction process, wherein each of the motion information candidates in the first list has at least one of an associated motion vector or an associated reference picture index, and the common list construction process is common to at least a first motion information prediction mode and a second motion information prediction mode. The video coder is further configured to code the first video block using the first motion information prediction mode based on a first motion information candidate selected from the first list. The video coder is further configured to generate a second list of motion information candidates for a second video block using the common list construction process, wherein each motion information candidate in the second list has at least one of an associated motion vector or an associated reference picture index, and code the second video block using the second motion information prediction mode based on a second motion information candidate selected from the second list.

In another example, an apparatus for coding video data comprises means for generating a first list of motion information candidates for a first video block using a common list construction process, wherein each of the motion information candidates in the first list has at least one of an associated motion vector or an associated reference picture index, and the common list construction process is common to at least a first motion information prediction mode and a second motion information prediction mode. The apparatus further comprises means for coding the first video block using the first motion information prediction mode based on a first motion information candidate selected from the first list. The apparatus further comprises means for generating a second list of motion information candidates for a second video block using the common list construction process, wherein each motion information candidate in the second list has at least one of an associated motion vector or an associated reference picture index, and means for coding the second video block using the second motion information prediction mode based on a second motion information candidate selected from the second list.

In another example, a computer-readable storage medium has stored thereon instructions that, when executed, cause one or more processors of an apparatus for coding video data to generate a first list of motion information candidates for a first video block using a common list construction process, wherein each of the motion information candidates in the first list has at least one of an associated motion vector or an associated reference picture index, and the common list construction process is common to at least a first motion information prediction mode and a second motion information prediction mode. The instructions further cause the one or more processors to code the first video block using the first motion information prediction mode based on a first motion information candidate selected from the first list. The instructions further cause the one or more processors to generate a second list of motion information candidates for a second video block using the common list construction process, wherein each motion information candidate in the second list has at least one of an associated motion vector or an associated reference picture index, and code the second video block using the second motion information prediction mode based on a second motion information candidate selected from the second list.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2 is a conceptual diagram illustrating an example video block, as well as representative spatial and temporal neighboring blocks for constructing a motion information candidate list for the example video block.

FIG. 3 is a block diagram illustrating an example video encoder that may implement the techniques described in this disclosure.

FIG. 4 is a block diagram illustrating an example video decoder that may implement the techniques described in this disclosure.

FIG. 5 is a flow diagram illustrating an example method that includes using a common motion information candidate list construction process to construct motion information candidate lists for different motion information prediction modes.

FIG. 6 is a flow diagram illustrating an example method that includes using a motion information candidate list construction process for one motion information prediction mode to generate a motion information prediction list for coding a video block according to another motion information prediction mode.

FIG. 7 is a flow diagram illustrating an example method for determining whether to scale a motion information candidate from a motion information candidate list constructed according to a process for a first motion information prediction mode prior to inclusion in a motion information candidate list for a second motion information prediction mode.

FIG. 8 is a flow diagram illustrating an example method for identifying motion information candidates from a motion information candidate list constructed according to a process for a first motion information prediction mode for inclusion in a motion information candidate list for a second motion information prediction mode.

### DETAILED DESCRIPTION

As discussed above, video compression techniques include temporal (inter-picture) prediction of blocks of video data, i.e., video blocks, relative to reference samples in another block in another picture. An inter-coded block is coded according to motion information, e.g., a motion vector that points to a block of reference samples forming the predictive block in the other picture. In some examples, to achieve further bitstream efficiency, the motion information, e.g., the motion vector, the prediction direction and reference picture index value, for a video block may itself be predicted using motion information prediction techniques, which are sometimes referred to as motion vector prediction (MVP) techniques.

According to such motion information prediction techniques, a video coder may derive the motion vector and/or other motion information for a current video block from a reference block. The reference blocks from which the motion information may be derived generally include a plurality of pre-defined spatially-neighboring blocks, and one or more co-located or neighboring blocks from one or more different (e.g., temporally) pictures. A video coder, e.g., a video encoder or video decoder, may construct a motion information candidate list, also referred to as a candidate list or candidate set, that includes the motion information of spatial and temporal neighboring blocks as candidate motion information for coding a video block. The video coder may encode or decode an index into the candidate list to identify the selected motion information candidate for coding the video block.

Efforts are currently in progress to develop a new video coding standard, currently referred to as High Efficiency Video Coding (HEVC). The upcoming standard is also referred to as H.265. The HEVC standard may also be referred to as ISO/IEC 23008-HEVC, which is intended to be the standard number for the delivered version of HEVC. The standardization efforts are based on a model of a video coding device referred to as the HEVC Test Model (HM). The HM presumes several capabilities of video coding devices over devices according to, previous coding standards, such as ITU-T H.264/AVC. For example, whereas H.264 provides nine intra-prediction encoding modes, the HM provides as many as thirty-five intra-prediction encoding modes.

A recent working Draft (WD) of HEVC, referred to as “HEVC Working Draft 6” or “WD6,” is described in document JCTVC-H1003, Bross et al., “High-Efficiency Video Coding (HEVC) text specification draft 6,” Joint Collaborative Team on Video Coding (JCT-VC) of ITU-T SG16 WP3 and ISO/IEC JTC1/SC29/WG11, 8th Meeting: San Jose, Calif., USA, February 2012, which is incorporated herein by reference in its entirety, and which as of Apr. 10, 2013, is downloadable from: http://phenix.int-evry.fr/jct/doc_end_user/documents/8_San%20Jose/wg11/JCTVC-H1003-v22.zip

Further, another recent working draft of HEVC, Working Draft 8, referred to as “HEVC Working Draft 8” or “WD8,” is described in document HCTVC-J1003_d7, Bross et al., “High Efficiency Video Coding (HEVC) Text Specification draft 8,” JCT-VC of ITU-T SG16 WP3 and ISO/IEC JTC1/SC29/WG11, 10th Meeting: Stockholm, Sweden, July 2012, which is incorporated herein by reference in its entirety, and which as of Apr. 10, 2013, is downloadable from: http://phenix.int-evry.fr/jct/doc_end_user/documents/10_Stockholm/wg11/JCTVC-J1003-v8.zip.

The HEVC standard continues to evolve, and a newer draft of the standard referred to as “HEVC Working Draft 10,” or “WD10,” is described in document JCTVC-L1003_v18, Bross et al., “High Efficiency Video Coding (HEVC) Text Specification Draft 10,” Joint Collaborative Team on Video Coding (JCT-VC) of ITU-T SG16 WP3 and ISO/IEC JTC1/SC29/WG11, 12th Meeting: Geneva, Switzerland, 14-23 Jan. 2013, which, as of Apr. 10, 2013, is downloadable from http://phenix.it-sudparis.eu/jct/doc_end_user/documents/12_Geneva/wg11/JCTVC-L1003-v18.zip. The entire content of WD10 is hereby incorporated by reference.

The motion information prediction modes for HEVC include a merge mode and an advanced motion vector prediction (AMVP) mode. For both modes, a video coder, e.g., a video encoder or video decoder, can construct a list of motion information candidates based on the motion information of spatially and temporally neighboring blocks.

Both the video encoder and the video decoder construct the motion information candidate list in the same defined manner. If a candidate is selected from the list of motion information candidates, then the video coder may use motion information associated with the selected candidate to encode/decode a current video block. For both the AMVP and the merge mode, a video encoder may signal, in an encoded bitstream of video data, an index value identifying the motion information candidate selected from the motion information candidate list constructed by the video encoder according to the defined process. Based on the index, the video decoder can identify the selected motion information candidate from the motion information candidate list constructed by the video decoder according to the defined process for decoding the current video block.

In merge mode, instead of only taking the motion vectors of the neighboring candidate blocks as motion vector predictors, a current video block can inherit motion vectors, reference picture indexes, and prediction directions from the one of the neighboring candidate blocks. Hence, for merge mode, each motion information candidate in a list of motion information candidates can include one or more motion vectors, reference picture indices, and inter-prediction directions. When coding a video block using the merge mode, instead of signaling motion vector information, reference picture index information, and prediction direction information, a video coder may instead signal only the index of a selected motion information candidate from the motion information candidate list as part of the encoded bitstream.

Video coders may also implement an AMVP mode that, similar to merge mode, includes expressing motion vectors as an index selecting one of a plurality of motion information candidates stored in a list of motion information candidates constructed in a defined manner. In AMVP mode, like the merge mode, the motion vectors of the neighboring blocks are used by video coders as motion information candidates. However, for AMVP mode, a video encoder determines a motion vector difference (MVD) between a desired motion vector for coding the video block and the motion vector indicated by the motion information candidate selected from the motion information candidate list. In addition to the index into the motion information candidate list and the MVD, video coders employing the AMVP mode may also signal in the coded bitstream a reference picture index, and an inter-prediction direction for coding a particular video block according to the AMVP mode.

According to proposals for the HEVC standard, both merge mode and AMVP consider the same neighboring blocks when constructing a MVC candidate list. For both merge mode and AMVP mode, a video coder (e.g., a video encoder or video decoder) uses a predetermined process to construct a list of motion vector candidates (MVCs). Both a video encoder and video decoder use the same process.

However, according to proposals for inclusion in the HEVC standard, AMVP and merge mode use different motion candidate list construction processes. For example, the AMVP mode and the merge mode may include different numbers (N) of motion information candidates in a motion information candidate list, consider the neighboring blocks (and more particularly the motion information of the neighboring blocks) in different orders, use different criteria for determining whether to include the motion information from a neighboring block in a motion information candidate list, use different criteria for determining whether to prune a motion information candidate from the motion information candidate list, or the like.

For example, the number (N) of motion information candidates in a merge mode motion information candidate list might be adaptive, e.g., explicitly signaled from a video encoder to a video decoder, with a maximum of five. For AMVP, however, the number (N) of motion information candidates might be a fixed number, such as two. Accordingly, the resulting motion information candidate lists for AMVP and merge mode, respectively, may be different. Implementing two different techniques for motion information candidate list construction may in some instances increase the complexity of codec implementation.

As will be described in greater detail below, the present disclosure describes techniques whereby a plurality of motion information prediction modes, such as the merge mode and AMVP mode, use a common motion information candidate list construction process. The common motion information candidate list construction process may include one or more of a common maximum number of motion information candidates for the motion information candidate list, a common scan order for consideration of motion information of neighboring blocks, common criteria for inclusion of motion information of neighboring blocks as a motion information candidate in the motion information candidate list, and a common process for pruning the motion information candidate list. The use of a common motion information candidate list construction process for multiple motion information prediction modes may result in reduced codec complexity relative to the use of separate processes for each mode, which may provide one or more benefits, such as a reduction in processing resource consumption and/or a reduction in battery consumption. In addition, while proposals for HEVC specify the use of common neighboring blocks as candidate blocks for merge mode and AMVP, the additional use of a common motion information candidate list construction process for multiple motion information prediction modes according to this disclosure may provide for even greater unification between the motion information prediction modes.

In some examples, one of the motion information prediction modes uses the motion information list construction process of the other motion information prediction mode instead of its own motion information candidate list construction process. For example, in the AMVP mode, the AMVP motion information candidate list construction process may be replaced by the merge mode motion information candidate list construction process. In such examples, both the merge mode and the AMVP mode may use the merge mode motion information candidate list construction process. For example, to implement an AMVP mode, a video coder may construct a merge mode motion information candidate list according to a merge mode list construction process, and then identify candidates from the merge mode list for inclusion in an AMVP mode motion information candidate list. In some examples, to implement the AMVP mode, the video coder may use the merge mode candidate list for coding the current video block according to the AMVP mode, i.e., rather than creating an AMVP candidate list include all or a subset of the merge mode motion information candidates. As the motion information candidates in the merge mode list may include motion vectors, prediction directions, and reference picture indices, and the AMVP mode candidates only need motion vectors, with the AMVP mode including signaling a prediction direction, reference index, and MVD, a video coder may include only the motion vectors of the candidates identified from the merge mode candidate list in the AMVP candidate list, or may remove or disregard other motion information, e.g., prediction directions and reference indices, in a merge mode candidate list used directly for AMVP mode coding.

Although described herein primarily in the context of using the merge mode candidate list construction process to construct a motion information candidate list for both merge mode and AMVP mode, in other examples, in the merge mode, the merge mode motion information candidate list construction process may be replaced by the AMVP motion information candidate list construction process. In such examples, both the merge mode and the AMVP mode may use the AMVP MVC candidate list construction process. In such examples, to implement the merge mode, a video coder may construct an AMVP mode motion information candidate list according to an AMVP mode list construction process, and then identify candidates from the AMVP mode list for inclusion in a merge mode motion information candidate list. In other examples, to implement the merge mode, a video coder may construct an AMVP mode motion information candidate list according to an AMVP mode list construction process, and then directly use the AMVP mode list for coding the current video block according to the merge mode.

As the motion information candidates in the AMVP mode list may include only motion vectors (because prediction directions and reference picture indices are explicitly signaled in AMVP mode), and the merge mode candidates may require motion vectors, prediction directions, and reference picture indices, a video coder may supplement the motion information candidates in the AMVP candidate list with inter-prediction directions and reference picture indices prior their inclusion in the in merge mode candidate list, or direct use for coding a video block according to the merge mode. A video coder may identify the inter-prediction directions and reference picture indices that are associated with the motion vectors of the candidates in the AMVP candidate list by referring to the neighboring blocks from which the motion vectors were derived.

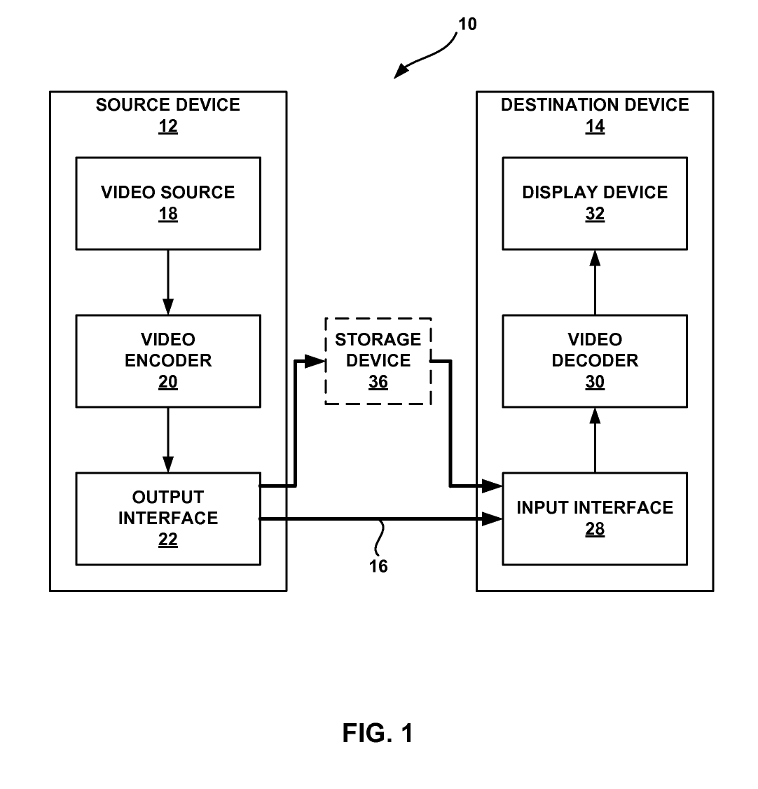

FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 36. Similarly, encoded data may be accessed from storage device 36 by input interface 28 of destination device 14. Storage device 36 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 36 may correspond to a file server or another intermediate storage device that may hold the encoded video generated by source device 12. Destination device 14 may access stored video data from storage device 36 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 36 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 36 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 may receive the encoded video data over link 16. The encoded video data communicated over link 16, or provided on storage device 36, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU is used for the transform and quantization processes. A given CU having one or more PUs may also include one or more transform units (TUs). Following prediction, video encoder 20 may calculate residual values corresponding to the PU. The residual values comprise pixel difference values that may be transformed into transform coefficients, quantized, and scanned using the TUs to produce serialized transform coefficients for entropy coding. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to an entropy encoding methodology. One example, of an entropy encoding methodology is context adaptive binary arithmetic coding (CABAC). Other example entropy encoding methodologies include context adaptive variable length coding (CAVLC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 may further send syntax data, such as block-based syntax data, frame-based syntax data, and GOP-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame.

In addition, video encoder 20 may decode encoded pictures, e.g., by inverse quantizing and inverse transforming residual data, and combine the residual data with prediction data. In this manner, video encoder 20 can simulate the decoding process performed by video decoder 30. Both video encoder 20 and video decoder 30, therefore, will have access to substantially the same decoded pictures for use in inter-picture prediction.

In general, video decoder 30 may perform a decoding process that is the inverse of the encoding process performed by video encoder. For example, video decoder 30 may perform entropy decoding using the inverse of the entropy encoding techniques used by video encoder to entropy encode the quantized video data. Video decoder 30 may further inverse quantize the video data using the inverse of the quantization techniques employed by video encoder 20, and may perform an inverse of the transformation used by video encoder 20 to produce the transform coefficients that quantized. Video decoder 30 may then apply the resulting residual blocks to adjacent reference blocks (intra-prediction) or reference blocks from another picture (inter-prediction) to produce the video block for eventual display. Video decoder 30 may be configured, instructed controlled or directed to perform the inverse of the various processes performed by video encoder 20 based on the syntax elements provided by video encoder 20 with the encoded video data in the bitstream received by video decoder 30.

For further efficiency of inter-picture prediction, video encoder 20 and video decoder 30 may implement techniques for motion information prediction, e.g., motion vector prediction (MVP). Modes of motion information prediction supported by the HM include, for example, merge mode and AMVP.

Merge mode refers to one or more video coding modes in which motion information, such as motion vectors, reference frame indices, prediction directions, or other information, for a current video block to be coded is inherited from a spatially-neighboring video block in the same picture as the current video block, or a co-located or neighboring video block in a (temporally) different picture. The spatially neighboring blocks in the same picture may be referred to as local spatial neighboring blocks. The co-located or neighboring blocks in a different picture may be referred to as temporal neighboring blocks.

To implement merge mode, video encoder 20 and video decoder 30 both implement a common, pre-defined process to evaluate the motion information of the neighboring blocks, and construct a motion information candidate list from such motion information. An index value, signaled from video encoder 20 to video decoder 30, may be used to identify which candidate in the candidate list is used to code the video block, and thus from which neighboring block the current video block inherits its motion information (e.g., a above, above-right, left, below-left, or above-left block, relative to the current block, or from a temporally adjacent picture).

Skip mode may comprise one type of merge mode (or a mode similar to merge mode). With skip mode, motion information is inherited, but no residual information is coded. Residual information generally refers to pixel difference information indicating pixel differences between an original, unencoded version of the block to be coded and a predictive block identified by the motion information inherited from the spatially neighboring block or co-located block. Direct mode may be another type of merge mode (or mode similar to merge mode). Direct mode may be similar to skip mode in that motion information is inherited, but with direct mode, a video block is coded to include residual information. The phrase “merge mode” is used herein to refer to any one of these modes, which may be called skip mode, direct mode or merge mode.

AMVP mode is similar to merge mode in that video encoder 20 and video decoder 30 implement a common, pre-defined process to evaluate the motion information local neighboring blocks and one or more temporal neighboring blocks, and construct a motion information candidate list for a video block based on the evaluated motion information. However, the pre-defined list construction process specified in the HM for AMVP is different than that for merge mode. Additionally, for AMVP, the video block does not inherit all of the candidate motion information. Rather, in AMVP, the video block inherits the motion vector from the selected candidate block, which is signaled from the video encoder 20 to video decoder 30 by an index into the motion information candidate list. In AMVP, the video encoder 20 signals other motion information, such as a reference picture index and prediction direction, to the video decoder 30. For AMVP, the video coder additionally signals motion vector differences, where the motion vector difference is a difference between the motion vector predictor identified by the index and an actual motion vector used to predict a current block. Thus, AMVP may provide greater video coding fidelity for the video block, by explicitly signaling more motion information for the video block, at the cost of reduced bit stream efficiency relative to merge mode.

According to the techniques of this disclosure, rather than perform different motion information candidate list construction processes for different motion information prediction modes, video encoder 20 and video decoder 30 may implement a common motion information candidate list construction process for coding video blocks according to different motion information prediction modes. In some examples, to code a video block according to one of the motion information prediction modes, e.g., merge mode or AMVP mode, video encoder 20 and video decoder 30 use the motion information list construction process of the other motion information prediction mode. For example, in the AMVP mode, the AMVP motion information candidate list construction process may be replaced by the merge mode motion information candidate list construction process.

In such examples, video encoder 20 and video decoder 30 may use the merge mode motion information candidate list construction process to construct a merge mode motion information candidate list when coding video blocks using the merge mode or the AMVP mode. For example, to code a video block according to the AMVP mode, video encoder 20 and video decoder 30 may construct a merge mode motion information candidate list according to merge mode list construction process, and then identify candidates from the merge mode list for inclusion in an AMVP mode motion information candidate list, or directly use the merge mode candidate list as the AMVP mode candidate list for coding a video block according to the AMVP mode. As the motion information candidates in the merge mode list will include motion vectors, prediction directions, and reference indices, and the AMVP mode candidates only need motion vectors, video encoder 20 and video decoder 30 may include only the motion vectors of the candidates identified from the merge mode candidate list in the AMVP candidate list, or otherwise remove or disregard the other motion information of the merge mode candidates.

In one example of using the merge candidate list construction process to generate the AMVP candidate list, the number of AMVP candidates can be fixed at N candidates, meaning video encoder 20 and video decoder 30 take only N candidates from the merge list to use in the AMVP motion candidate list. These N candidates can be the first N candidates (according to a merge mode ordering) from the merge mode motion information candidate list, or generally can be any N candidates of the merge list. As long as the same rules in selecting the N candidates are implemented by both video encoder 20 and video decoder 30, then the AMVP candidate lists generated by both the encoder and decoder should be the same. According to one technique of this disclosure, if a number of candidates in a merge list is less than N, then zero MV candidates can be added to fill up the list up to N candidates in the AMVP candidate list for use under AMVP mode. According to the proposals for HEVC, for AMVP N=2.

In some cases, for a merge mode motion information candidate to be used as a motion information predictor for AMVP, the motion information candidate from the merge mode motion information candidate list may need to be additionally scaled based on the reference picture signaled for coding the video block according to the AMVP mode. A motion information candidate from the merge mode candidate list can be taken as is for use in the AMVP motion information candidate list if the motion information candidate indicates the same reference picture list and has same reference picture index as signaled for coding the current video block according to the AMVP mode. A motion information candidate from the merge mode candidate list may also be taken as is for use in the AMVP motion information candidate list if the candidate indicates a different reference picture list, but the reference picture index indicates a reference picture with the same picture order count (POC) as the reference picture POC identified by the reference index signaled for coding the current video block according to the AMVP mode. In other cases, video encoder 20 and video decoder 30 may scale the motion information candidate from the merge mode motion information candidate list prior to including the motion information candidate from the merge mode list in the AMVP motion information candidate list. Video encoder 20 and video decoder 30 may scale the motion information candidate from the merge mode list based on a difference between the reference picture POC related to the reference index of the motion information candidate and the reference picture POC identified by the signaled reference index for coding the current video block according to the AMVP mode.

According to another technique of this disclosure, to choose the N candidates from the merge mode motion information candidate list for inclusion in the AMVP mode motion information candidate list, video encoder 20 and video decoder 30 may perform a multi-pass process. For example, in a first pass, video encoder 20 and video decoder 30 may identify candidates from the merge mode motion information candidate list having the same reference list (i.e., inter-prediction direction) and the same reference picture index or same reference picture POC as the one signaled for coding the current video block according to the AMVP mode for inclusion in the AMVP motion information candidate list. Motion information candidates from the merge mode list identified during such a first pass may not need to be scaled prior to inclusion in the AMVP mode motion information candidate list.

If, after the first pass, the number of motion information candidates is the AMVP candidate list is still less than N, then video encoder 20 and video decoder 30 may perform a second pass. In the second pass, video encoder 20 and video decoder 30 may identify motion information candidates in the merge mode candidate list that indicate a different reference picture list, but whose reference picture index indicates a reference picture with the same picture order count (POC) as the reference picture POC identified by the reference index signaled for coding the current video block according to the AMVP mode for inclusion in the AMVP mode motion information candidate list. Motion information candidates from the merge mode list identified during such a second pass may not need to be scaled prior to inclusion in the AMVP mode motion information candidate list.

If after the second pass the number of motion information candidates in the AMVP mode motion information candidate list is still less than N, then video encoder 20 and video decoder 30 may perform a third pass. In this third pass, video encoder 20 and video decoder 30 may scale remaining candidates from the merge mode motion information candidate list based on a difference between a reference picture POC of the motion information candidate and a reference picture POC signaled for coding the current block according to the AMVP mode, e.g., a reference picture POC indicated by a reference picture index value signaled for coding the current video block according to the AMVP mode. The encoder and decoder may use such scaled motion information candidates from the merge mode motion information candidate list to fill in the N candidates needed for the AMVP mode motion information candidate list. The number of scaled motion information candidates can be up to N, which again may be a maximum number of motion information candidates in a AMVP mode motion information candidate list. The maximum number of motion information candidates in the AMVP mode list may be less than a maximum number of motion information candidates in a merge mode motion information candidate list. For example, the maximum number of motion information candidates in the AMVP mode list may be 2, while the maximum number of motion information candidates in a merge mode motion information candidate list may be variably determined by video encoder 20 and signaled to video decoder 30, and may be as great as 5.

Again, motion information candidates in a merge mode candidate list may include a motion vector, a reference picture list or inter-prediction direction, a reference picture index value, and reference picture POC value associated with the said reference index. Motion information candidates in an AMVP mode motion information candidate list may include only a motion vector, and video encoder 20 may explicitly signal the prediction direct and reference picture index value (which may indicate the reference picture POC) to video decoder 30 for coding a current video block according to the AMVP mode. Accordingly, when identifying motion information candidates from a merge mode candidate list for inclusion in an AMVP candidate list, video encoder 20 and video decoder 30 may include only the motion vectors of the motion information candidates identified from the merge mode list in the AMVP candidate list.

Additionally, in some cases, video encoder 20 and video decoder 30 may scale the motion vectors of motion information candidates in the merge mode candidate list prior to their inclusion as motion information candidates in the AMVP mode candidate list. The encoder and decoder may scale the motion vectors based on a difference between the reference picture POC associated with the reference index of the motion information candidate and a reference picture POC signaled for coding the current video block according to the AMVP mode. For example, video encoder 20 and video decoder 30 may not need to scale a motion vector if the motion information candidate in the merge mode candidate list has the same reference picture list (inter-prediction direction) and reference picture index value (or same reference picture POC associated with the said reference picture index value) as was signaled for coding the current video block according to the AMVP mode. Video encoder 20 and video decoder 30 may also not need to scale a motion vector if the motion information candidate in the merge mode candidate list specifies a different reference picture list, but the reference picture indicated by the reference picture index of the merge mode candidate has the same POC as the reference picture POC signaled for coding the current video block according to the AMVP mode. Video encoder 20 and video decoder 30 may scale other motion information candidates identified from the merge mode candidate list for inclusion in the AMVP mode motion information candidate list based on a difference between a reference picture POC related to the reference picture index of the motion information candidate and the reference picture POC identified by the signaled reference picture index for coding the current video block according to the AMVP mode. A reference picture associated with a motion vector candidate or signaled for AMVP mode may be identified by the reference picture list (i.e., inter-prediction direction) and the reference picture index.

Accordingly, video encoder 20 is an example of a video encoder configured, according to the techniques of this disclosure to, generate a first list of motion information candidates for a first video block using a common list construction process, wherein each of the motion information candidates in the first list has at least one of an associated motion vector or an associated reference picture index, and the common list construction process is common to at least a first motion information prediction mode and a second motion information prediction mode. Video encoder 20 is an example of a video encoder further configured, according to the techniques of this disclosure, to encode the first video block using the first motion information prediction mode based on a first motion information candidate selected from the first list. Video encoder 20 is an example of a video encoder further configured, according to the techniques of this disclosure, to generate a second list of motion information candidates for a second video block using the common list construction process, wherein each motion information candidate in the second list has at least one of an associated motion vector or an associated reference picture index, and encode the second video block using the second motion information prediction mode based on a second motion information candidate selected from the second list.

Additionally, video decoder 30 is an example of a video decoder configured, according to the techniques of this disclosure, to generate a first list of motion information candidates for a first video block using a common list construction process, wherein each of the motion information candidates in the first list has at least one of an associated motion vector or an associated reference picture index, and the common list construction process is common to at least a first motion information prediction mode and a second motion information prediction mode. Video decoder 30 is an example of a video decoder further configured, according to the techniques of this disclosure, to decode the first video block using the first motion information prediction mode based on a first motion information candidate selected from the first list. Video decoder 30 is an example of a video decoder further configured, according to the techniques of this disclosure to, generate a second list of motion information candidates for a second video block using the common list construction process, wherein each motion information candidate in the second list has at least one of an associated motion vector or an associated reference picture index, and decode the second video block using the second motion information prediction mode based on a second motion information candidate selected from the second list.

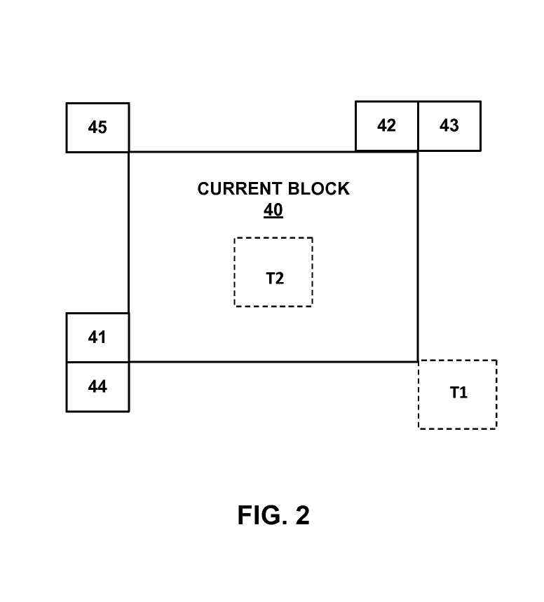

FIG. 2 is a conceptual diagram illustrating an example of a current video block 40, as well as representative spatial and temporal neighboring blocks for constructing a motion information candidate list for the example video block 40. As discussed above, both merge mode and AMVP mode include identifying motion information candidates for a current video block being coded from the motion information of spatial and temporal neighboring blocks. Furthermore, according to proposals for the HEVC, for both merge mode and AMVP mode, a video coder may consider the motion information of the same candidate blocks, e.g., the set of candidate blocks illustrated by FIG. 2, when constructing a motion information candidate lists.

The example of FIG. 2 illustrates spatial neighboring blocks 41-45 and temporal neighboring blocks T1 and T2 as neighboring blocks whose motion information may be considered potential motion information candidates for coding current block 40 according to the merge mode or AMVP mode. Block 41 (left neighbor), block 42 (above neighbor), block 43 (above-right neighbor), block 44 (below-left neighbor) and block 45 (above-left neighbor) are the spatial neighboring blocks for current video block 40 illustrated in FIG. 2. Blocks 41-45 may be the spatial neighboring blocks for identifying motion information candidates for constructing a motion information candidate list for coding current video block 40 according to either or both of merge mode or AMVP mode.

Temporal neighboring blocks T1 and T2 are shown adjacent to and within current video block 40, respectively, but have dashed borders to reflect that they are in fact located in a different picture than (and are thus temporal neighbors to) current video block 40. One or both of temporal neighboring blocks T1 and T2 may be a temporal neighboring block for identifying motion information candidates for constructing a motion information candidate list for coding current video block 40 according to either or both of merge mode or AMVP mode. The temporal candidate block T1 may be below-right of current block 40 (but from the reference picture), and temporal candidate T2 can be at or near the center of a current video block 40 (but from the reference picture), as shown in FIG. 2.

According to the techniques of this disclosure, video encoder 20 and video decoder 30 may each form the list of motion information candidates in the same or similar manner for use in coding current block 40 according to the merge mode or AMVP mode. After selecting a candidate from the candidate list, video encoder 20 can signal to the video decoder an index of the selected candidate. Based on the index, the video decoder, such as video decoder 30, can identify the candidate selected by video encoder 20. Based on motion information associated with the selected candidate, video decoder 30 can decode a current video block. In order to select the proper candidate from the candidate list, video decoder 30 can construct the same candidate set used by video encoder 20. Accordingly, the techniques of this disclosure for constructing candidate lists can be performed by both video encoders, such as video encoder 20, and video decoders, such as video decoder 30.

In proposals for the emerging HEVC coding standard, video blocks can be coded using a merge inter prediction mode and a skip mode based on merge mode, where motion information such as a motion vector, reference picture index, and inter direction from a motion information candidate can be copied to the motion information of a current block 40. In some examples, five spatial candidates can be considered along with one temporal motion information candidate (sometimes referred to as a temporal motion vector predictor or “TMVP”) to form a list of candidates, e.g., a list of up to five motion information candidates. According to proposals for HEVC, the total number of candidates to be used in a merge mode motion information candidate list is fixed at five (or may be selected by a video encoder with a maximum value of five), with the list including up to four spatial motion information candidates and one temporal motion information candidate. Accordingly, in some examples, a merge mode motion information candidate list may include four of the spatial candidates (i.e., four of the candidates indicated by blocks 41-45 in FIG. 2) and one temporal motion information candidate (i.e., one of the two candidates indicated by blocks T1 and T2 in FIG. 2). The temporal motion information candidate can be T1 or, if T1 is not available, T2.

If one of the spatial or temporal motion information candidates is unavailable, or redundant with an already included motion information candidate, then the video coder may replace the redundant or unavailable candidate with the fifth spatial candidate. In some examples, a redundant or unavailable candidate may be replaced by the other of T1 or T2. The numbering shown in FIG. 2 may correspond to an example ordering in which the spatial candidates might be added to the list of candidates. Hence, using this example ordering, spatial candidate 45 would be the fifth spatial candidate and added after spatial candidates 41-44.

The scan order for consideration of the motion information neighboring candidate blocks 41-45, T1 and T2 for inclusion in the motion information candidate list may be, for example, 41-44, T1, 45. In other examples, any scan order for may be used, so long as it is employed by both video encoder 20 and video decoder 30. For example, in other configurations, the fifth spatial candidate may be considered before the temporal motion information candidate. The scan order with which a motion information candidate is considered for addition to the motion information candidate list may, for example, affect the index associated with that candidate. If there are five candidates in a list with indexes 0 to 4, the temporal motion information candidate may be assigned to any of those indexes. Similarly, the spatial candidates may also be assigned to any index.

Some of the techniques of this disclosure have been described with reference to an example that uses a maximum of five candidates in a candidate list. The same techniques, however, can be applied to lists having any number of candidates. Additionally, the number of spatial and temporal candidates used can also vary. Furthermore, the order of spatial candidates shown in FIG. 2 is one of many possible orders.

The above techniques for motion information candidate list construction are intended to represent one example of how a motion information candidate list can be constructed. The techniques of this disclosure, which generally concern using a single list construction process for multiple motion information prediction modes, e.g., both merge mode and AMVP mode, can also be implemented with other list construction methods. Furthermore, although the examples described below generally relate to using the merge mode motion information candidate list construction process for generating the both the merge mode candidate list and the AMVP candidate list, the techniques of this disclosure are generally applicable to any use of the candidate list construction process for one MVP mode to construct the candidate list for another MVP mode. Accordingly, the techniques of this disclosure are applicable to using the AMVP mode candidate list construction process, e.g., as specified by HEVC, to generate the motion information candidate list for merge mode.

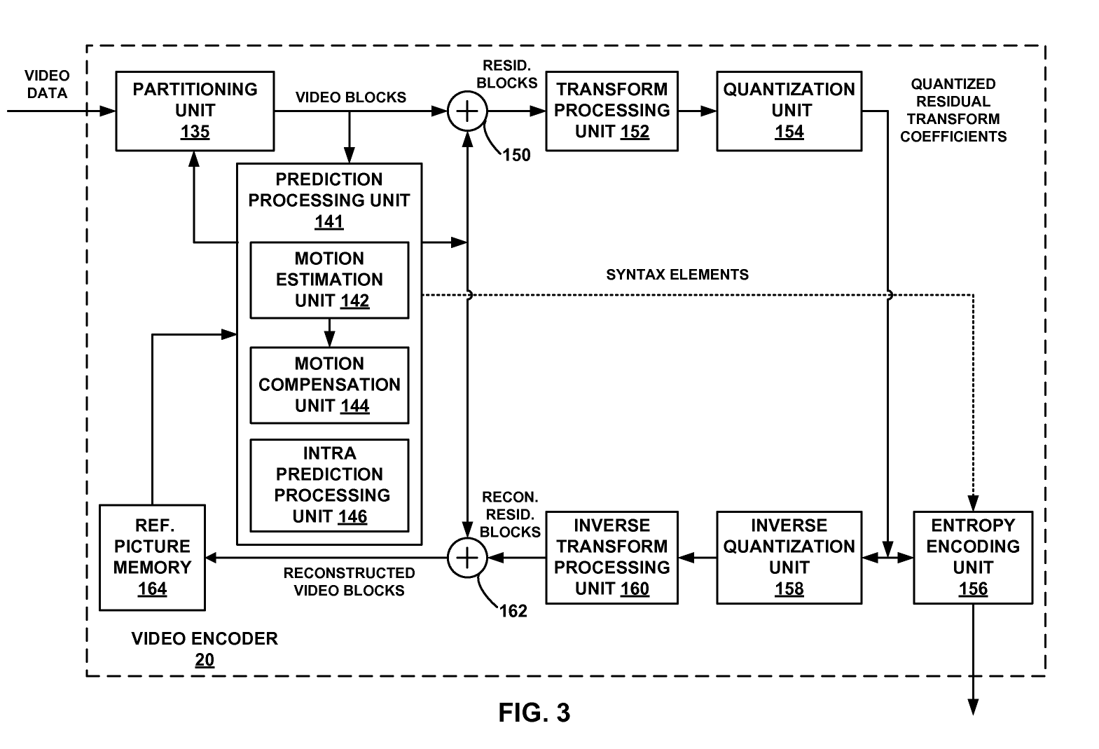

FIG. 3 is a block diagram illustrating an example video encoder 20 that may implement the techniques described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 3, video encoder 20 includes a partitioning unit 135, prediction processing unit 141, reference picture memory 164, summer 150, transform processing unit 152, quantization unit 154, and entropy encoding unit 156. Prediction processing unit 141 includes motion estimation unit 142, motion compensation unit 144, and intra prediction processing unit 146. For video block reconstruction, video encoder 20 also includes inverse quantization unit 158, inverse transform processing unit 160, and summer 162. A deblocking filter (not shown in FIG. 3) may also be included to filter block boundaries to remove blockiness artifacts from reconstructed video. If desired, the deblocking filter would typically filter the output of summer 162. Additional loop filters (in loop or post loop) may also be used in addition to the deblocking filter.

As shown in FIG. 3, video encoder 20 receives video data, and partitioning unit 135 partitions the data into video blocks. This partitioning may also include partitioning into slices, tiles, or other larger units, as wells as video block partitioning, e.g., according to a quadtree structure of LCUs and CUs. The example configuration of video encoder 20 illustrated in FIG. 3 generally illustrates the components that encode video blocks within a video slice to be encoded. The slice may be divided into multiple video blocks (and possibly into sets of video blocks referred to as tiles).

Prediction processing unit 141 may select one of a plurality of possible coding modes, such as one of a plurality of intra coding modes or one of a plurality of inter coding modes, for the current video block based on error results (e.g., coding rate and the level of distortion). Prediction processing unit 141 may provide the resulting intra- or inter-coded block to summer 150 to generate residual block data and to summer 162 to reconstruct the encoded block for use as a reference picture.

Intra prediction processing unit 146 within prediction processing unit 141 may perform intra-predictive coding of the current video block relative to one or more neighboring blocks in the same frame or slice as the current block to be coded to provide spatial compression. Motion estimation unit 142 and motion compensation unit 144 within prediction processing unit 141 perform inter-predictive coding of the current video block relative to one or more predictive blocks in one or more reference pictures to provide temporal compression.

Motion estimation unit 142 may be configured to determine the inter-prediction mode for a video slice according to a predetermined pattern for a video sequence. The predetermined pattern may designate video slices in the sequence as P slices, B slices or GPB slices. Motion estimation unit 142 and motion compensation unit 144 may be highly integrated, but are illustrated separately for conceptual purposes. Motion estimation, performed by motion estimation unit 142, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 164. For example, video encoder 20 may interpolate values of one-quarter pixel positions, one-eighth pixel positions, or other fractional pixel positions of the reference picture. Therefore, motion estimation unit 142 may perform a motion search relative to the full pixel positions and fractional pixel positions and output a motion vector with fractional pixel precision.

Motion estimation unit 142 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 164. Motion estimation unit 142 sends the calculated motion vector to entropy encoding unit 156 and motion compensation unit 144.

Motion compensation, performed by motion compensation unit 144, may involve fetching or generating the predictive block based on the motion vector determined by motion estimation, possibly performing interpolations to sub-pixel precision. Upon receiving the motion vector for the PU of the current video block, motion compensation unit 144 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 150 represents the component or components that perform this subtraction operation. Motion compensation unit 144 may also generate syntax elements associated with the video blocks and the video slice for use by video decoder 30 in decoding the video blocks of the video slice.

Intra-prediction processing unit 146 may intra-predict a current block, as an alternative to the inter-prediction performed by motion estimation unit 142 and motion compensation unit 144, as described above. In particular, intra-prediction processing unit 146 may determine an intra-prediction mode to use to encode a current block. In some examples, intra-prediction processing unit 146 may encode a current block using various intra-prediction modes, e.g., during separate encoding passes, and intra-prediction processing unit 146 (or a mode select unit (not shown), in some examples) may select an appropriate intra-prediction mode to use from the tested modes. For example, intra-prediction processing unit 146 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction processing unit 146 may calculate ratios from the distortions and rates for the various encoded blocks to determine which intra-prediction mode exhibits the best rate-distortion value for the block.

In any case, after selecting an intra-prediction mode for a block, intra-prediction processing unit 146 may provide information indicative of the selected intra-prediction mode for the block to entropy encoding unit 156. Entropy encoding unit 156 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

After prediction processing unit 141 generates the predictive block for the current video block via either inter-prediction or intra-prediction, video encoder 20 forms a residual video block by subtracting the predictive block from the current video block. The residual video data in the residual block may be included in one or more TUs and applied to transform processing unit 152. Transform processing unit 152 transforms the residual video data into residual transform coefficients using a transform, such as a discrete cosine transform (DCT) or a conceptually similar transform. Transform processing unit 152 may convert the residual video data from a pixel domain to a transform domain, such as a frequency domain.

Transform processing unit 152 may send the resulting transform coefficients to quantization unit 154. Quantization unit 154 quantizes the transform coefficients to further reduce bit rate. The quantization process may reduce the bit depth associated with some or all of the coefficients. The degree of quantization may be modified by adjusting a quantization parameter. In some examples, quantization unit 154 may then perform a scan of the matrix including the quantized transform coefficients. Alternatively, entropy encoding unit 156 may perform the scan.

Following quantization, entropy encoding unit 156 entropy encodes the quantized transform coefficients. For example, entropy encoding unit 156 may perform context adaptive binary arithmetic coding (CABAC), context adaptive variable length coding (CAVLC), syntax-based context-adaptive binary arithmetic coding (SBAC), probability interval partitioning entropy (PIPE) coding or another entropy encoding methodology or technique. Following the entropy encoding by entropy encoding unit 156, the encoded bitstream may be transmitted to video decoder 30, or archived for later transmission or retrieval by video decoder 30. Entropy encoding unit 156 may also entropy encode the motion vectors, other motion information, and the other syntax elements for the current video slice being coded.

Inverse quantization unit 158 and inverse transform processing unit 160 apply inverse quantization and inverse transformation, respectively, to reconstruct the residual block in the pixel domain for later use as a reference block of a reference picture. Motion compensation unit 144 may calculate a reference block by adding the residual block to a predictive block of one of the reference pictures within one of the reference picture lists. Motion compensation unit 144 may also apply one or more interpolation filters to the reconstructed residual block to calculate sub-integer pixel values for use in motion estimation. Summer 162 adds the reconstructed residual block to the motion compensated prediction block produced by motion compensation unit 144 to produce a reference block for storage in reference picture memory 164. The reference block may be used by motion estimation unit 142 and motion compensation unit 144 as a reference block to inter-predict a block in a subsequent video frame or picture.

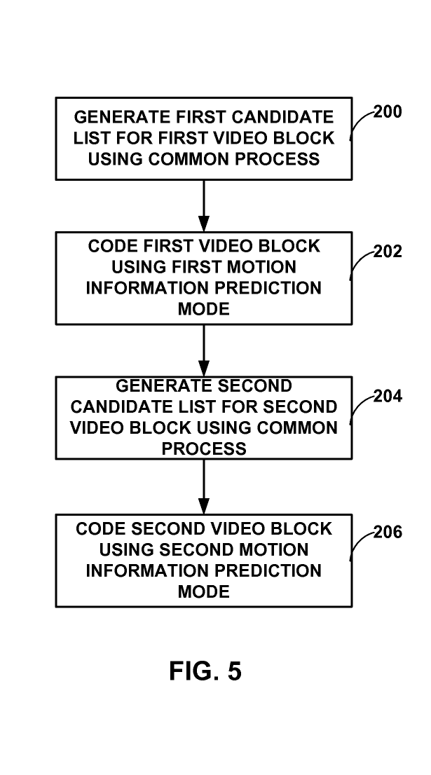

Motion estimation and motion compensation, e.g., as performed by motion estimation unit 142 and motion compensation unit 144, may include motion information prediction according to a plurality of different motion information prediction modes, e.g., merge mode and AMVP mode. According to the techniques of this disclosure, the motion information prediction according to the plurality of motion information prediction modes may include a common motion information candidate list construction process. In some examples, motion estimation unit 142 and/or motion compensation unit 144 may generate a motion information candidate list according to the list construction process for one of the motion information prediction modes, e.g., the merge mode, which can be used when coding a video block according to either the merge mode or the AMVP mode. In general, motion estimation unit 142 and/or motion compensation unit 144 may perform any of the techniques described herein (e.g., including those described below with respect to FIGS. 5-8) for using a common motion information candidate list construction process to construct motion information candidate lists for a plurality of motion information prediction modes.

Accordingly, video encoder 20 is an example of a video encoder configured, according to the techniques of this disclosure to, generate a first list of motion information candidates for a first video block using a common list construction process, wherein each of the motion information candidates in the first list has at least one of an associated motion vector or an associated reference picture index, and the common list construction process is common to at least a first motion information prediction mode and a second motion information prediction mode. Video encoder 20 is an example of a video encoder further configured, according to the techniques of this disclosure, to encode the first video block using the first motion information prediction mode based on a first motion information candidate selected from the first list. Video encoder 20 is an example of a video encoder further configured, according to the techniques of this disclosure, to generate a second list of motion information candidates for a second video block using the common list construction process, wherein each motion information candidate in the second list has at least one of an associated motion vector or an associated reference picture index, and encode the second video block using the second motion information prediction mode based on a second motion information candidate selected from the second list.

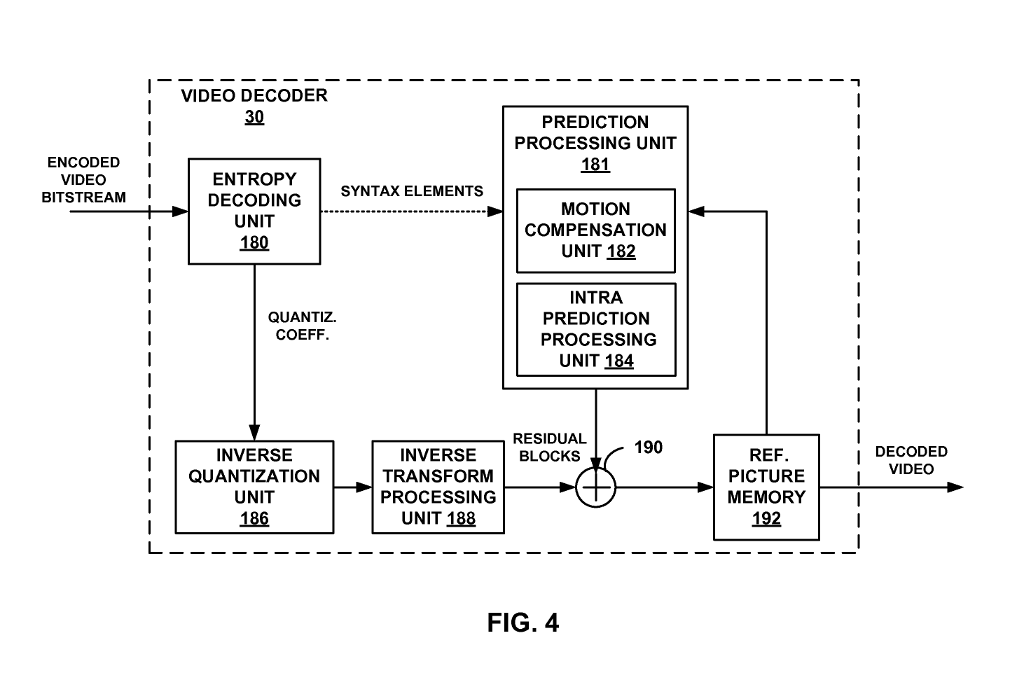

FIG. 4 is a block diagram illustrating an example video decoder 30 that may implement the techniques described in this disclosure. In the example of FIG. 4, video decoder 30 includes an entropy decoding unit 180, prediction processing unit 181, inverse quantization unit 186, inverse transformation processing unit 188, summer 190, and reference picture memory 192. Prediction processing unit 181 includes motion compensation unit 182 and intra prediction processing unit 184. Video decoder 30 may, in some examples, perform a decoding pass generally reciprocal to the encoding pass described with respect to video encoder 20 from FIG. 3.

During the decoding process, video decoder 30 receives an encoded video bitstream that represents video blocks of an encoded video slice and associated syntax elements from video encoder 20. Entropy decoding unit 180 of video decoder 30 entropy decodes the bitstream to generate quantized coefficients, motion vectors, other motion information, and other syntax elements. Entropy decoding unit 180 forwards the motion information and other syntax elements to prediction processing unit 181. Video decoder 30 may receive the syntax elements at the video slice level and/or the video block level, as examples.

When the video slice is coded as an intra-coded (I) slice, intra prediction processing unit 184 of prediction processing unit 181 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 182 of prediction processing unit 181 produces predictive blocks for a video block of the current video slice based on the motion vectors and other syntax elements received from entropy decoding unit 180. The predictive blocks may be produced from one of the reference pictures within one of the reference picture lists. Video decoder 30 may construct the reference frame lists, List 0 and List 1, using default construction techniques based on reference pictures stored in reference picture memory 192.

Motion compensation unit 182 determines prediction information for a video block of the current video slice by parsing the motion vectors and other syntax elements, and uses the prediction information to produce the predictive blocks for the current video block being decoded. For example, motion compensation unit 182 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 182 may also perform interpolation based on interpolation filters. Motion compensation unit 182 may use interpolation filters as used by video encoder 20 during encoding of the video blocks to calculate interpolated values for sub-integer pixels of reference blocks. In this case, motion compensation unit 182 may determine the interpolation filters used by video encoder 20 from the received syntax elements and use the interpolation filters to produce predictive blocks.

Inverse quantization unit 186 inverse quantizes, i.e., de-quantizes, the quantized transform coefficients provided in the bitstream and decoded by entropy decoding unit 180. The inverse quantization process may include use of a quantization parameter calculated by video encoder 20 for each video block in the video slice to determine a degree of quantization and, likewise, a degree of inverse quantization that should be applied. Inverse transform processing unit 188 applies an inverse transform, e.g., an inverse DCT, an inverse integer transform, or a conceptually similar inverse transform process, to the transform coefficients in order to produce residual blocks in the pixel domain.

After motion compensation unit 182 generates the predictive block for the current video block based on the motion vectors and other syntax elements, video decoder 30 forms a decoded video block by summing the residual blocks from inverse transform processing unit 188 with the corresponding predictive blocks generated by motion compensation unit 182. Summer 190 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 192, which stores reference pictures used for subsequent motion compensation. Reference picture memory 192 also stores decoded video for later presentation on a display device, such as display device 32 of FIG. 1.

Motion estimation, which may be performed in video decoder 30 by prediction processing unit 181 and/or motion compensation unit 182 as part of the motion compensation process, may include motion information prediction according to a plurality of motion information prediction modes, e.g., the merge mode and AMVP mode. According to the techniques of this disclosure, the motion information prediction according to the plurality of motion information prediction modes may include a common motion information candidate list construction process. In some examples, prediction processing unit 181 and/or motion compensation unit 182 may generate a motion information candidate list according to the list construction process for one of the motion information prediction modes, e.g., the merge mode, which can be used when coding a video block according to either the merge mode or the AMVP mode.

Prediction processing unit 181 and/or motion compensation unit 182 may receive syntax elements included in the bitstream by video encoder 20 from entropy decoding unit 180, which may indicate the motion information prediction mode for decoding a current video block. If the motion information prediction mode is the AMVP mode, the syntax elements from video encoder 20 may also include a prediction direction, reference picture index, and MVD for the current video block. In some examples, if the motion information prediction mode is the AMVP mode, prediction processing unit 181 and/or motion compensation unit 182 may generate a motion information candidate list using the merge mode motion information candidate list construction process. In general, motion estimation unit 142 and/or motion compensation unit 144 may perform any of the techniques described herein (e.g., including those described below with respect to FIGS. 5-8) for using a common motion information candidate list construction process to construct motion information candidate lists for a plurality of motion information prediction modes.

In this manner, video decoder 30 of FIG. 4 represents an example of a video decoder configured, according to the techniques of this disclosure to, generate a first list of motion information candidates for a first video block using a common list construction process, wherein each of the motion information candidates in the first list has at least one of an associated motion vector or an associated reference picture index, and the common list construction process is common to at least a first motion information prediction mode and a second motion information prediction mode. Video decoder 30 is an example of a video decoder further configured, according to the techniques of this disclosure, to decode the first video block using the first motion information prediction mode based on a first motion information candidate selected from the first list. Video decoder 30 is an example of a video decoder further configured, according to the techniques of this disclosure to, generate a second list of motion information candidates for a second video block using the common list construction process, wherein each motion information candidate in the second list has at least one of an associated motion vector or an associated reference picture index, and decode the second video block using the second motion information prediction mode based on a second motion information candidate selected from the second list.

FIG. 5 is a flow diagram illustrating an example method that includes using a common motion information candidate list construction process to construct motion information candidate lists for different motion information prediction modes. According to the example method of FIG. 5, a video coder, e.g., video encoder 20 or video decoder 30, generates a first motion information candidate list for a first video block using a common motion information candidate list construction process (200). The video coder further codes, e.g., encodes or decodes, the first video block based on the motion information of one of the candidates selected from the first candidate list according to a first motion information prediction mode (202). The video coder then may generate a second motion information candidate list for coding a second video block using the same common process used for generating the first motion information candidate list for coding the first video block (204). However, the video coder may code, e.g., encode or decode, the second video block based on the motion information of one of the candidates selected from the second candidate list according to a second motion information prediction mode, different from the first motion information prediction mode used to code the first video block (206).

As can be seen, according to the example of FIG. 5, the common list construction process is common to at least the first motion information prediction mode and the second motion information prediction mode. The common list construction process for the first and second motion information prediction modes may comprise, for each motion information candidate list constructed according to the common list construction process, a common maximum number of motion information candidates for the motion information candidate list, a common scan order for consideration of motion information of neighboring blocks, common criteria for inclusion of motion information of neighboring blocks as a motion information candidate in the motion information candidate list, and a common process for pruning the motion information candidate list. In some examples, the first motion information prediction mode comprises a merge mode, the second motion information prediction mode comprises an AMVP mode, and the common motion information candidate list construction process comprises a motion information candidate list construction process for the merge mode. Each of the motion information candidates in the first and second motion information candidate list may have an associated motion vector and, in some cases, additional motion information, such as a reference picture index. In examples in which the motion information candidate list construction process comprises the list construction process for the merge mode, each of the candidates in the list may also include a prediction direction and a reference picture index.

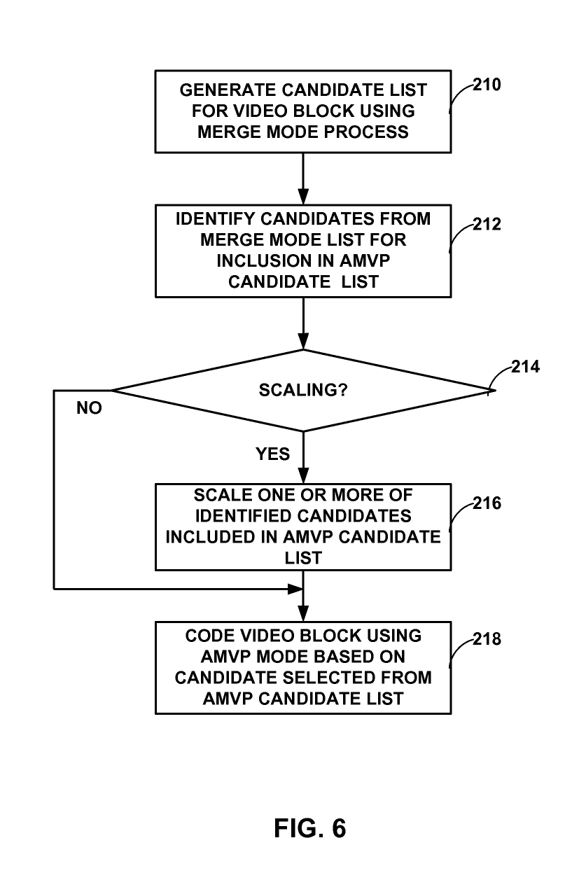

FIG. 6 is a flow diagram illustrating an example method that includes using a motion information candidate list construction process for one motion information prediction mode to generate a motion information prediction list for coding a video block according to another motion information prediction mode. More particularly, FIG. 6 is a flow diagram illustrating an example method that includes using the motion information candidate list construction process for the merge mode to generate a motion information candidate list for coding a current video block according to the AMVP mode. As described herein, in other examples, the motion information candidate list construction process for the AMVP mode may be used to generate a motion information candidate list for coding a current video block according to the merge mode.

According to the example method of FIG. 6, a video coder, e.g., video encoder 20 or video decoder 30, generates a motion information candidate list for a current video block using a merge mode process, e.g., using the neighboring blocks and process described above with respect to FIG. 2 (210). The video coder then identifies motion information candidates from the merge mode list for inclusion in the AMVP mode motion information candidate list to be used for coding the current video block (212).

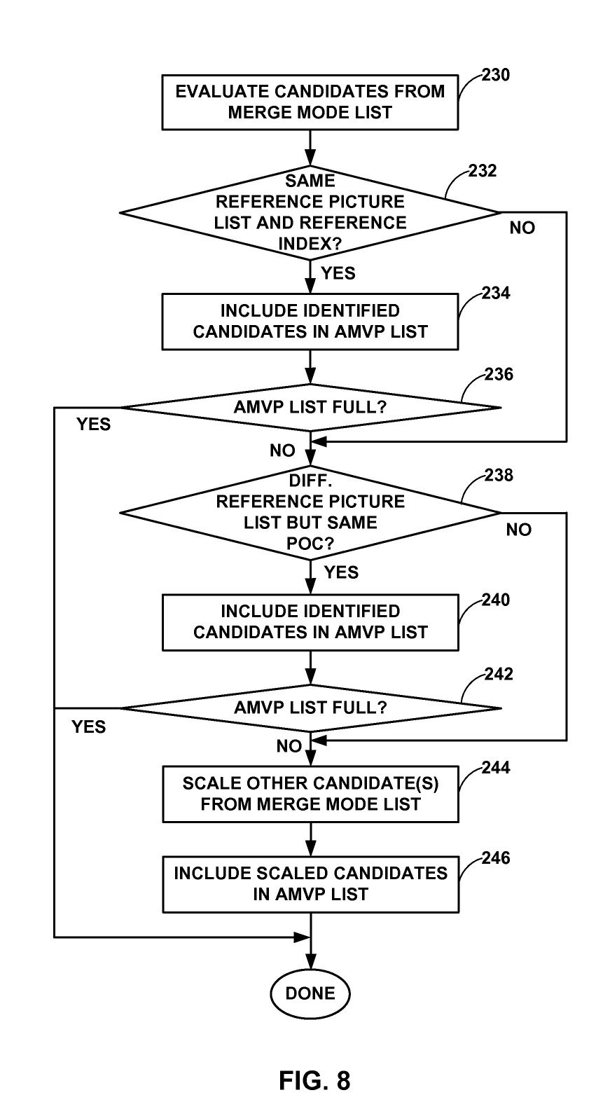

In some examples, the number of AMVP candidates can be fixed and equal to N=2, meaning only two candidates are taken from the merge mode list and used for an AMVP list. These N candidates can be the first N candidates from the merge list, e.g., according to an ordering of motion information candidates in the merge mode list, or generally can be any N candidates from the merge mode list. As long as the same rules in selecting the N candidates are implemented by both a video encoder and decoder, then the lists generated by both the encoder and decoder can be synchronize d. According to one technique of this disclosure, if a number of candidates in a merge mode list is less than N, then zero motion vector candidates can be added to fill up the list up to N candidates for coding the current video block according to AMVP mode. In some examples, e.g., as described below with respect to FIG. 8, a video coder may perform a multi-pass process to preferentially identify certain motion information candidates from the merge mode candidate list for inclusion in the AMVP mode candidate list.

Furthermore, in some examples, a video coder need not identify a subset of the motion information candidates in the merge mode candidate list for inclusion in an AMVP mode candidate list. In such examples, a video coder may directly use a merge mode candidate list constructed according to a merge mode list construction process as an AMVP mode candidate list for coding a current video block according to the AMVP mode.

As described herein, the motion information candidates in the merge mode candidate list will include inter-prediction directions and reference picture indices in addition to motion vectors. However, the AMVP motion information candidates need not include inter-prediction directions and reference picture indices, as the inter-prediction direction and reference picture index are signaled for coding the current video block according to the AMVP mode. Accordingly, a coder including a motion information candidate from the merge mode list in an AMVP mode list, or otherwise using the merge mode list for coding a current video block according to the AMVP mode, may include in the AMVP mode list the motion vectors specified by the candidates in the merge mode list, but not the inter-prediction directions and reference picture indices specified by the candidates in the merge mode list.

For a merge mode motion information candidate to be used as a predictor for AMVP mode, the motion information candidate, e.g., the motion vector specified by the merge mode motion information candidate, may need to be additionally scaled based on the reference picture signaled for coding the current video block according to the AMVP mode. According to the example method of FIG. 6, a video coder determines whether any of the motion information candidates identified from the merge mode list need to be scaled prior to inclusion in the AMVP mode candidate list (214). If one or more of the motion information candidates from the merge mode candidate list need to be scaled (YES of 214), the video coder may scale the identified candidates based on a difference between the reference picture POC specified by the reference indices of the candidates and the reference picture POC related to the signaled reference picture index for coding the current video block according to the AMVP mode (216). In either case, the video coder codes, e.g., encodes or decodes, the current video block using the AMVP mode based on a motion information candidate selected from the AMVP candidate list constructed according to the method of FIG. 6.

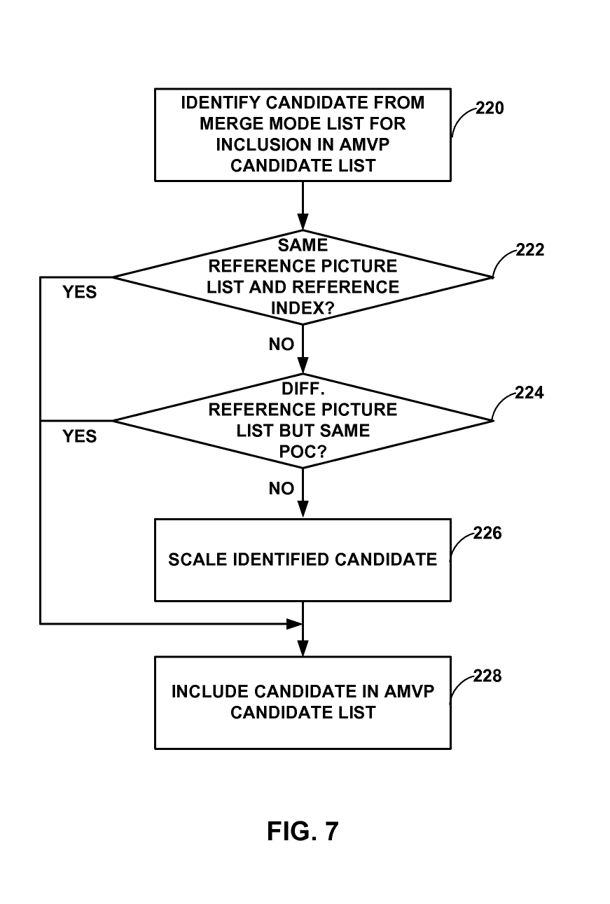

FIG. 7 is a flow diagram illustrating an example method for determining whether to scale a motion information candidate from a motion information candidate list constructed according to a process for a first motion information prediction mode prior to inclusion in a motion information candidate list for a second motion information prediction mode. According to the example method of FIG. 7, a video coder, e.g., video encoder 20 or video decoder 30, may identify a motion information candidate from a merge mode candidate list for inclusion in an AMVP mode candidate list (220). The video coder then determines whether the identified candidate from the merge mode list has the same reference picture list (e.g., prediction direction) and reference index as selected (signaled) for coding the current video block according to the AMVP mode (222). In other words, the video coder determines if the motion information candidate from the merge mode list refers to the same reference picture as specified for coding the current video block according to the AMVP mode. If so (YES of 222), the video coder may include the candidate from the merge mode candidate list in the AMVP candidate list without scaling the merge mode motion information candidate e.g., scaling the motion vector of the merge mode candidate based on the difference between the reference picture POC specified by the merge mode candidate and the reference picture POC indicated by the signaled reference index for coding the current block according to the AMVP mode (228).

If the motion information candidate from the merge mode candidate list does not refer to the same reference picture list and have the same reference picture index as specified for coding the current video block according to the AMVP mode (NO of 222), the video coder may determine whether the candidate refers to a different reference picture list, but the reference picture index indicates a reference picture with the same POC as the reference picture POC identified by the reference index signaled for coding the current video block according to the AMVP mode, e.g., whether the reference picture for the merge mode candidate is an already scaled version of the reference picture signaled for coding the current video block according to the AMVP mode (224). If so (YES of 222), the video coder may include the candidate from the merge mode candidate list in the AMVP candidate list without further scaling the merge mode motion information candidate e.g., scaling the motion vector of the merge mode candidate based on the difference between the reference picture POC specified by the reference index of the merge mode candidate and the reference picture POC associated with the signaled reference picture index for coding the current block according to the AMVP mode (228).

If the motion information candidate from the merge mode candidate list does not have the same POC as the reference picture specified for coding the current video block according to the AMVP mode (NO of 224), the video coder may scale the identified candidate based on a difference between the reference picture POC specified by the reference index of the identified candidate from the merge mode list and the reference picture POC specified by the reference index for coding the current video block according to the AMVP mode (226). The video coder may scale the motion information candidate from the merge mode candidate list by scaling the motion vector of the motion information candidate. Again, including motion information candidates from the merge mode list in an AMVP mode list may comprise including the motion vectors of the merge mode candidates in the AMVP mode list, without the prediction directions and reference picture indices specified by the motion information candidates in the merge mode list. The video coder may then include the scaled motion information candidates, e.g., motion vectors, the AMVP motion information candidate list (228).

FIG. 8 is a flow diagram illustrating an example method for identifying motion information candidates from a motion information candidate list constructed according to a process for a first motion information prediction mode for inclusion in a motion information candidate list for a second motion information prediction mode. More particularly, FIG. 8 is a flow diagram illustrating an example method for identifying motion information candidates from a motion information candidate list constructed according merge mode motion information candidate list construction process for inclusion in a motion information candidate list for coding a current video block according to the AMVP mode.

According to the example method of FIG. 8, a video coder, e.g., video encoder 20 or video decoder 30, evaluates the candidates, e.g., five candidates, included in a merge mode motion information candidate list constructed according to the merge mode list construction process, e.g., described above with respect to FIG. 2 (230). The video coder may, e.g., in a first evaluation pass, identify candidates in the merge mode list indicating the same reference picture list (i.e., inter-prediction direction) and reference picture index as specified or signaled for coding the current video block according to the AMVP mode (232). The video coder may include any such motion information candidates (YES of 232) from the merge mode candidate list in the AMVP mode motion information candidate list (234).

If any such motion information candidates were identified in this first pass, the video coder may determine whether the AMVP candidate list is full, e.g., includes N=2 motion vectors (236). If the AMVP candidate list is not full, e.g., includes less than N=2 motion vectors (NO of 236), or no motion information candidates in the merge mode list met the criteria of the first pass (NO of 232), the video coder may, e.g., in a second evaluation pass, identify candidates in the merge mode list that indicate a different reference picture list, but whose reference picture index indicates a reference picture with the same POC as the reference picture POC identified by the reference index signaled for coding the current video block according to the AMVP mode (238). The video coder may include any such motion information candidates (YES of 238) from the merge mode candidate list in the AMVP mode motion information candidate list (240).

If any such motion information candidates were identified in this second pass, the video coder may determine whether the AMVP candidate list is full, e.g., includes N=2 motion vectors (242). If the AMVP candidate list is not full, e.g., includes less than N=2 motion vectors (NO of 242), or no motion information candidates in the merge mode list met the criteria of the second pass (NO of 238), the video coder may, e.g., in a third evaluation pass, identify any remaining motion information candidates in the merge mode candidate list that could be included in the AMVP mode motion information candidate list. The video coder may further scale the candidates from the merge mode list identified during the third pass based on a difference between a reference picture POC specified by the candidates reference picture index and a reference picture POC specified by the reference picture index for coding the current video block according to the AMVP mode (244). The video coder may then include the scaled motion information candidates, e.g., scaled motion vectors, in the AMVP mode candidate list (246). Although not illustrated in FIG. 8, if the number of motion information candidates identified from the merge mode list for inclusion in the AMVP mode list after these three evaluation passes is less than the maximum size of the AMVP list e.g., N=2, the video coder may include zero motion vectors or other artificial candidates in the AMVP mode motion information candidate list.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
generating a first list of motion information candidates for a first video block using a common list construction process, wherein each of the motion information candidates in the first list has at least one of an associated motion vector or an associated reference picture index, and the common list construction process is common to at least a first motion information prediction mode and a second motion information prediction mode;
decoding the first video block using the first motion information prediction mode based on a first motion information candidate selected from the first list;
generating a second list of motion information candidates for a second video block using the common list construction process, wherein each motion information candidate in the second list has at least one of an associated motion vector or an associated reference picture index; and
decoding the second video block using the second motion information prediction mode based on a second motion information candidate selected from the second list.

2. The method of claim 1, wherein the first motion information prediction mode comprises a merge mode, the second motion information prediction mode comprises an advanced motion vector prediction (AMVP) mode, and the common motion information candidate list construction process comprises a motion information candidate list construction process for the merge mode.

3. The method of claim 2, wherein generating the second list of motion information candidates for the second video block using the common motion information candidate list construction process comprises:
performing the merge mode motion information candidate list construction process to determine a merge mode motion information candidate list; and
identifying motion information candidates from the merge mode motion information candidate list for inclusion in the second list of motion information candidates for the AMVP mode, and
wherein decoding the second video block using the second motion information prediction mode comprises decoding the second video block using the AMVP mode based on the second motion information candidate selected from the second list.

4. The method of claim 3,
wherein a maximum number of candidates for the second list of motion information candidates for the AMVP mode is N, and
wherein identifying motion information candidates from the merge mode motion information candidate list for inclusion in the second list of motion information candidates for the AMVP mode comprises identifying N motion information candidates from the merge mode list for inclusion in the second list of motion information candidates for the AMVP mode.

5. The method of claim 4, wherein N is less than a maximum number of candidates for the merge mode motion information candidate list construction process.

6. The method of claim 4, wherein identifying N motion information candidates comprises identifying a first N motion information candidates according to an order of the motion information candidates in the merge mode list.

7. The method of claim 3, further comprising scaling one or more of the motion information candidates identified from the merge mode motion information candidate list for inclusion the second list of motion information candidates for the AMVP mode based on a difference between a reference picture picture order count (POC) specified by a reference picture index of the identified motion information candidate and a reference picture POC specified by a reference picture index signaled for coding the second video block using the AMVP mode.

8. The method of claim 7, wherein scaling one of more of the motion information candidates identified from the merge mode motion information candidate list for inclusion the second list of motion information candidates for the AMVP mode comprises:
if the reference picture index and a reference picture list of the identified motion information candidate are the same as a reference picture list and a reference picture index signaled for coding the second video block using the AMVP mode, including the identified motion information candidate in the second list of motion information candidates without scaling the identified motion information candidate;
if the reference picture list of the identified motion information candidate is different than the reference picture list signaled for coding the second video block using the AMVP mode, but the reference picture POC specified by the reference picture index of the identified motion information candidate is the same as the reference picture POC specified by the reference picture index signaled for the AMVP mode, including the identified motion information candidate in the second list of motion information candidates without scaling the identified motion information candidate; and
otherwise scaling the identified candidate based on the difference between the reference picture POC specified by the reference index of the identified motion information candidate and the reference picture POC specified by the reference picture index signaled for coding the second video block using the AMVP mode.

9. The method of claim 3, wherein identifying motion information candidates from the merge mode motion information candidate list for inclusion in the second list of motion information candidates for the AMVP mode comprises identifying motion information candidates in the merge mode list having a reference picture list and a reference picture index that are the same as a reference picture list and a reference picture index signaled for coding the second video block using the AMVP mode.

10. The method of claim 9, wherein identifying motion information candidates from the merge mode motion information candidate list for inclusion in the second list of motion information candidates for the AMVP mode further comprises:
if a number of motion information candidates in the merge mode list having the same reference picture list and the same reference index as the reference picture list and the reference picture index signaled for coding the second video block using the AMVP mode is less than a maximum number of candidates for the second list of motion information candidates for the AMVP mode, identifying motion information candidates in the merge mode list having a different reference picture list than the reference picture list signaled for coding the second video block using the AMVP mode, but whose reference picture index specifies a reference picture picture order count (POC) that is the same as a reference picture POC specified by the reference picture index signaled for coding the second video block using the AMVP mode.

11. The method of claim 10, wherein identifying motion information candidates from the merge mode motion information candidate list for inclusion in the second list of motion information candidates for the AMVP mode further comprises:
if a number of motion information candidates in the merge mode list having the same reference picture list and reference picture index as signaled for coding the second video block using the AMVP mode, or a having a different reference picture list than the reference picture list signaled for coding the second video block using the AMVP mode but whose reference picture index specifies the same reference picture POC as specified by the reference picture index signaled for coding the second video block using the AMVP mode is less than a maximum number of candidates for the second list of motion information candidates for the AMVP mode:
identifying at least one motion information candidate remaining in the merge mode motion information candidate list; and
scaling the identified motion information candidate based on a difference between a reference picture POC specified by the reference index of the identified motion information candidate and the reference picture POC specified by the reference picture index signaled for coding the second video block using the AMVP mode.

12. The method of claim 1, wherein the common list construction process for the first and second motion information prediction modes comprises, for each motion information candidate list constructed according to the common list construction process, a common maximum number of motion information candidates for the motion information candidate list, a common scan order for consideration of motion information of neighboring blocks, common criteria for inclusion of motion information of neighboring blocks as a motion information candidate in the motion information candidate list, and a common process for pruning the motion information candidate list.

13. A method of encoding video data, the method comprising:
generating a first list of motion information candidates for a first video block using a common list construction process, wherein each of the motion information candidates in the first list has at least one of an associated motion vector or a reference index, and the common list construction process is common to at least a first motion information prediction mode and a second motion information prediction mode;
encoding the first video block using the first motion information prediction mode based on a first motion information candidate selected from the first list;
generating a second list of motion information candidates for a second video block using the common list construction process, wherein each motion information candidate in the second list has at least one of an associated motion vector or a reference index; and
encoding the second video block using the second motion information prediction mode based on a second motion information candidate selected from the second list.

14. The method of claim 13, wherein the first motion information prediction mode comprises a merge mode, the second motion information prediction mode comprises an advanced motion vector prediction (AMVP) mode, and the common motion information candidate list construction process comprises a motion information candidate list construction process for the merge mode.

15. The method of claim 14, wherein generating the second list of motion information candidates for the second video block using the common motion information candidate list construction process comprises:
performing the merge mode motion information candidate list construction process to determine a merge mode motion information candidate list; and
identifying motion information candidates from the merge mode motion information candidate list for inclusion in the second list of motion information candidates for the AMVP mode, and
wherein encoding the second video block using the second motion information prediction mode comprises encoding the second video block using the AMVP mode based on the second motion information candidate selected from the second list.

16. The method of claim 15,
wherein a maximum number of candidates for the second list of motion information candidates for the AMVP mode is N, and
wherein identifying motion information candidates from the merge mode motion information candidate list for inclusion in the second list of motion information candidates for the AMVP mode comprises identifying N motion information candidates from the merge mode list for inclusion in the second list of motion information candidates for the AMVP mode.

17. The method of claim 16, wherein N is less than a maximum number of candidates for the merge mode motion information candidate list construction process.

18. The method of claim 16, wherein identifying N motion information candidates comprises identifying a first N motion information candidates according to an order of the motion information candidates in the merge mode list.

19. The method of claim 15, further comprising scaling one or more of the motion information candidates identified from the merge mode motion information candidate list for inclusion the second list of motion information candidates for the AMVP mode based on a difference between a reference picture picture order count (POC) specified by a reference picture index of the identified motion information candidate and a reference picture POC specified by a reference picture index signaled for coding the second video block using the AMVP mode.

20. The method of claim 19, wherein scaling one of more of the motion information candidates identified from the merge mode motion information candidate list for inclusion the second list of motion information candidates for the AMVP mode comprises:
if the reference picture index and a reference picture list of the identified motion information candidate are the same as a reference picture list and a reference picture index signaled for coding the second video block using the AMVP mode, including the identified motion information candidate in the second list of motion information candidates without scaling the identified motion information candidate;
if the reference picture list of the identified motion information candidate is different than the reference picture list signaled for coding the second video block using the AMVP mode, but the reference picture POC specified by the reference picture index of the identified motion information candidate is the same as the reference picture POC specified by the reference picture index signaled for the AMVP mode, including the identified motion information candidate in the second list of motion information candidates without scaling the identified motion information candidate; and
otherwise scaling the identified candidate based on the difference between the reference picture POC specified by the reference index of the identified motion information candidate and the reference picture POC specified by the reference picture index signaled for coding the second video block using the AMVP mode.

21. The method of claim 15, wherein identifying motion information candidates from the merge mode motion information candidate list for inclusion in the second list of motion information candidates for the AMVP mode comprises identifying motion information candidates in the merge mode list having a reference picture list and a reference picture index that are the same as a reference picture list and a reference picture index signaled for coding the second video block using the AMVP mode.

22. The method of claim 21, wherein identifying motion information candidates from the merge mode motion information candidate list for inclusion in the second list of motion information candidates for the AMVP mode further comprises:
if a number of motion information candidates in the merge mode list having the same reference picture list and the same reference index as the reference picture list and the reference picture index signaled for coding the second video block using the AMVP mode is less than a maximum number of candidates for the second list of motion information candidates for the AMVP mode, identifying motion information candidates in the merge mode list having a different reference picture list than the reference picture list signaled for coding the second video block using the AMVP mode, but whose reference picture index specifies a reference picture picture order count (POC) that is the same as a reference picture POC specified by the reference picture index signaled for coding the second video block using the AMVP mode.

23. The method of claim 22, wherein identifying motion information candidates from the merge mode motion information candidate list for inclusion in the second list of motion information candidates for the AMVP mode further comprises:
if a number of motion information candidates in the merge mode list having the same reference picture list and reference picture index as signaled for coding the second video block using the AMVP mode, or a having a different reference picture list than the reference picture list signaled for coding the second video block using the AMVP mode but whose reference picture index specifies the same reference picture POC as specified by the reference picture index signaled for coding the second video block using the AMVP mode is less than a maximum number of candidates for the second list of motion information candidates for the AMVP mode:
identifying at least one motion information candidate remaining in the merge mode motion information candidate list; and
scaling the identified motion information candidate based on a difference between a reference picture POC specified by the reference index of the identified motion information candidate and the reference picture POC specified by the reference picture index signaled for coding the second video block using the AMVP mode.

24. The method of claim 13, wherein the common list construction process for the first and second motion information prediction modes comprises, for each motion information candidate list constructed according to the common list construction process, a common maximum number of motion information candidates for the motion information candidate list, a common scan order for consideration of motion information of neighboring blocks, common criteria for inclusion of motion information of neighboring blocks as a motion information candidate in the motion information candidate list, and a common process for pruning the motion information candidate list.

25. An apparatus for coding video data, the apparatus comprising a video coder configured to:
generate a first list of motion information candidates for a first video block using a common list construction process, wherein each of the motion information candidates in the first list has at least one of an associated motion vector or an associated reference picture index, and the common list construction process is common to at least a first motion information prediction mode and a second motion information prediction mode;
code the first video block using the first motion information prediction mode based on a first motion information candidate selected from the first list;
generate a second list of motion information candidates for a second video block using the common list construction process, wherein each motion information candidate in the second has at least one of an associated motion vector or an associated reference picture index; and
code the second video block using the second motion information prediction mode based on a second motion information candidate selected from the second list.

26. The apparatus of claim 25, wherein the first motion information prediction mode comprises a merge mode, the second motion information prediction mode comprises an advanced motion vector prediction (AMVP) mode, and the common motion information candidate list construction process comprises a motion information candidate list construction process for the merge mode.

27. The apparatus of claim 26, wherein the video coder is configured to generate the second list of motion information candidates for the second video block using the common motion information candidate list construction process by at least:
performing the merge mode motion information candidate list construction process to determine a merge mode motion information candidate list; and
identifying motion information candidates from the merge mode motion information candidate list for inclusion in the second list of motion information candidates for the AMVP mode, and
wherein the video coder is configured to code the second video block using the AMVP mode based on the second motion information candidate selected from the second list.

28. The apparatus of claim 27,
wherein a maximum number of candidates for the second list of motion information candidates for the AMVP mode is N, and
wherein the video coder is configured to identify N motion information candidates from the merge mode list for inclusion in the second list of motion information candidates for the AMVP mode.

29. The apparatus of claim 28, wherein N is less than a maximum number of candidates for the merge mode motion information candidate list construction process.

30. The apparatus of claim 28, wherein the video coder is configured to identify a first N motion information candidates according to an order of the motion information candidates in the merge mode list.

31. The apparatus of claim 27, wherein the video coder is further configured to scale one or more of the motion information candidates identified from the merge mode motion information candidate list for inclusion the second list of motion information candidates for the AMVP mode based on a difference between a reference picture picture order count (POC) specified by a reference picture index of the identified motion information candidate and a reference picture POC specified by a reference picture index signaled for coding the second video block using the AMVP mode.

32. The apparatus of claim 31, wherein:
if the reference picture index and a reference picture list of the identified motion information candidate are the same as a reference picture list and a reference picture index signaled for coding the second video block using the AMVP mode, the video coder is configured to include the identified motion information candidate in the second list of motion information candidates without scaling the identified motion information candidate;
if the reference picture list of the identified motion information candidate is different than the reference picture list signaled for coding the second video block using the AMVP mode, but the reference picture POC specified by the reference picture index of the identified motion information candidate is the same as the reference picture POC specified by the reference picture index signaled for the AMVP mode, the video coder is configured to include the identified motion information candidate in the second list of motion information candidates without scaling the identified motion information candidate; and
otherwise the video coder is configured to scale the identified candidate based on the difference between the reference picture POC specified by the reference index of the identified motion information candidate and the reference picture POC specified by the reference picture index signaled for coding the second video block using the AMVP mode.

33. The apparatus of claim 27, wherein the video coder is configured to identify motion information candidates from the merge mode motion information candidate list for inclusion in the second list of motion information candidates for the AMVP mode by at least identifying motion information candidates in the merge mode list having a reference picture list and a reference picture index that are the same as a reference picture list and a reference picture index signaled for coding the second video block using the AMVP mode.

34. The apparatus of claim 33, wherein, if a number of motion information candidates in the merge mode list having the same reference picture list and the same reference index as the reference picture list and the reference picture index signaled for coding the second video block using the AMVP mode is less than a maximum number of candidates for the second list of motion information candidates for the AMVP mode, the video coder is configured to identify motion information candidates in the merge mode list having a different reference picture list than the reference picture list signaled for coding the second video block using the AMVP mode, but whose reference picture index specifies a reference picture picture order count (POC) that is the same as a reference picture POC specified by the reference picture index signaled for coding the second video block using the AMVP mode.

35. The apparatus of claim 34, wherein, if a number of motion information candidates in the merge mode list having the same reference picture list and reference picture index as signaled for coding the second video block using the AMVP mode, or a having a different reference picture list than the reference picture list signaled for coding the second video block using the AMVP mode but whose reference picture index specifies the same reference picture POC as specified by the reference picture index signaled for coding the second video block using the AMVP mode is less than a maximum number of candidates for the second list of motion information candidates for the AMVP mode, the video coder is further configured to:
identify at least one motion information candidate remaining in the merge mode motion information candidate list; and
scale the identified motion information candidate based on a difference between a reference picture POC specified by the reference index of the identified motion information candidate and the reference picture POC specified by the reference picture index signaled for coding the second video block using the AMVP mode.

36. The apparatus of claim 25, wherein the common list construction process for the first and second motion information prediction modes comprises, for each motion information candidate list constructed according to the common list construction process, a common maximum number of motion information candidates for the motion information candidate list, a common scan order for consideration of motion information of neighboring blocks, common criteria for inclusion of motion information of neighboring blocks as a motion information candidate in the motion information candidate list, and a common process for pruning the motion information candidate list.

37. The apparatus of claim 25, wherein the video coder comprises a video encoder configured to:
encode the first video block using the first motion information prediction mode based on the first motion information candidate selected from the first list, and
encode the second video block using the second motion information prediction mode based on the second motion information candidate selected from the second list.

38. The apparatus of claim 25, wherein the video coder comprises a video decoder configured to:
decode the first video block using the first motion information prediction mode based on the first motion information candidate selected from the first list, and
decode the second video block using the second motion information prediction mode based on the second motion information candidate selected from the second list.

39. The apparatus of claim 25, wherein the apparatus comprises at least one of:
an integrated circuit;
a microprocessor; and
a wireless communication device that includes the video coder.

40. An apparatus for coding video data, the apparatus comprising:
means for generating a first list of motion information candidates for a first video block using a common list construction process, wherein each of the motion information candidates in the first list has at least one of an associated motion vector or an associated reference picture index, and the common list construction process is common to at least a first motion information prediction mode and a second motion information prediction mode;
means for coding the first video block using the first motion information prediction mode based on a first motion information candidate selected from the first list;
means for generating a second list of motion information candidates for a second video block using the common list construction process, wherein each motion information candidate in the second list has at least one of an associated motion vector or an associated reference picture index; and
means for coding the second video block using the second motion information prediction mode based on a second motion information candidate selected from the second list.

41. The apparatus of claim 40, wherein the first motion information prediction mode comprises a merge mode, the second motion information prediction mode comprises an advanced motion vector prediction (AMVP) mode, and the common motion information candidate list construction process comprises a motion information candidate list construction process for the merge mode.

42. The apparatus of claim 41, wherein the means for generating the second list of motion information candidates for the second video block using the common motion information candidate list construction process comprises:
means for performing the merge mode motion information candidate list construction process to determine a merge mode motion information candidate list; and
means for identifying motion information candidates from the merge mode motion information candidate list for inclusion in the second list of motion information candidates for the AMVP mode, and
wherein the means for coding the second video block using the second motion information prediction mode comprises means for coding the second video block using the AMVP mode based on the second motion information candidate selected from the second list.

43. The apparatus of claim 42,
wherein a maximum number of candidates for the second list of motion information candidates for the AMVP mode is N,
wherein the means for identifying motion information candidates from the merge mode motion information candidate list for inclusion in the second list of motion information candidates for the AMVP mode comprises means for identifying a first N motion information candidates according to an order of the motion information candidates in the merge mode list.

44. The apparatus of claim 42, further comprising means for scaling one or more of the motion information candidates identified from the merge mode motion information candidate list for inclusion the second list of motion information candidates for the AMVP mode based on a difference between a reference picture picture order count (POC) specified by a reference picture index of the identified motion information candidate and a reference picture POC specified by a reference picture index signaled for coding the second video block using the AMVP mode.

45. The apparatus of claim 44, wherein the means for scaling one of more of the motion information candidates identified from the merge mode motion information candidate list for inclusion the second list of motion information candidates for the AMVP mode comprises means for:
if the reference picture index and a reference picture list of the identified motion information candidate are the same as a reference picture list and a reference picture index signaled for coding the second video block using the AMVP mode, including the identified motion information candidate in the second list of motion information candidates without scaling the identified motion information candidate;
if the reference picture list of the identified motion information candidate is different than the reference picture list signaled for coding the second video block using the AMVP mode, but the reference picture POC specified by the reference picture index of the identified motion information candidate is the same as the reference picture POC specified by the reference picture index signaled for the AMVP mode, including the identified motion information candidate in the second list of motion information candidates without scaling the identified motion information candidate; and
otherwise scaling the identified candidate based on the difference between the reference picture POC specified by the reference index of the identified motion information candidate and the reference picture POC specified by the reference picture index signaled for coding the second video block using the AMVP mode.

46. The apparatus of claim 42, wherein the means for identifying motion information candidates from the merge mode motion information candidate list for inclusion in the second list of motion information candidates for the AMVP mode comprises means for identifying motion information candidates in the merge mode list having a reference picture list and a reference picture index that are the same as a reference picture list and a reference picture index signaled for coding the second video block using the AMVP mode.

47. The apparatus of claim 46, wherein the means for identifying motion information candidates from the merge mode motion information candidate list for inclusion in the second list of motion information candidates for the AMVP mode further comprises means for:
if a number of motion information candidates in the merge mode list having the same reference picture list and the same reference index as the reference picture list and the reference picture index signaled for coding the second video block using the AMVP mode is less than a maximum number of candidates for the second list of motion information candidates for the AMVP mode, identifying motion information candidates in the merge mode list having a different reference picture list than the reference picture list signaled for coding the second video block using the AMVP mode, but whose reference picture index specifies a reference picture picture order count (POC) that is the same as a reference picture POC specified by the reference picture index signaled for coding the second video block using the AMVP mode.

48. The apparatus of claim 47, wherein the means for identifying motion information candidates from the merge mode motion information candidate list for inclusion in the second list of motion information candidates for the AMVP mode further comprises means for:
if a number of motion information candidates in the merge mode list having the same reference picture list and reference picture index as signaled for coding the second video block using the AMVP mode, or a having a different reference picture list than the reference picture list signaled for coding the second video block using the AMVP mode but whose reference picture index specifies the same reference picture POC as specified by the reference picture index signaled for coding the second video block using the AMVP mode is less than a maximum number of candidates for the second list of motion information candidates for the AMVP mode:
identifying at least one motion information candidate remaining in the merge mode motion information candidate list; and
scaling the identified motion information candidate based on a difference between a reference picture POC specified by the reference index of the identified motion information candidate and the reference picture POC specified by the reference picture index signaled for coding the second video block using the AMVP mode.

49. The apparatus of claim 40, wherein the common list construction process for the first and second motion information prediction modes comprises, for each motion information candidate list constructed according to the common list construction process, a common maximum number of motion information candidates for the motion information candidate list, a common scan order for consideration of motion information of neighboring blocks, common criteria for inclusion of motion information of neighboring blocks as a motion information candidate in the motion information candidate list, and a common process for pruning the motion information candidate list.

50. A computer-readable storage medium having stored thereon instructions that, when executed, cause one or more processors of an apparatus for coding video data to:
generate a first list of motion information candidates for a first video block using a common list construction process, wherein each of the motion information candidates in the first list has at least one of an associated motion vector or an associated reference picture index, and the common list construction process is common to at least a first motion information prediction mode and a second motion information prediction mode;
code the first video block using the first motion information prediction mode based on a first motion information candidate selected from the first list;
generate a second list of motion information candidates for a second video block using the common list construction process, wherein each motion information candidate in the second list has at least one of an associated motion vector or an associated reference picture index; and
code the second video block using the second motion information prediction mode based on a second motion information candidate selected from the second list.

51. The computer-readable storage medium of claim 50, wherein the first motion information prediction mode comprises a merge mode, the second motion information prediction mode comprises an advanced motion vector prediction (AMVP) mode, and the common motion information candidate list construction process comprises a motion information candidate list construction process for the merge mode.

52. The computer-readable storage medium of claim 51, wherein the instructions that cause the one or more processors to generate the second list of motion information candidates for the second video block using the common motion information candidate list construction process comprise instructions that cause the one or more processors to:
perform the merge mode motion information candidate list construction process to determine a merge mode motion information candidate list; and
identify motion information candidates from the merge mode motion information candidate list for inclusion in the second list of motion information candidates for the AMVP mode, and
wherein the instructions that cause the one or more processors to code the second video block using the second motion information prediction mode comprise instructions that cause the one or more processors to code the second video block using the AMVP mode based on the second motion information candidate selected from the second list.

53. The computer-readable storage medium of claim 52,
wherein a maximum number of candidates for the second list of motion information candidates for the AMVP mode is N,
wherein the instructions that cause the one or more processors to identify motion information candidates from the merge mode motion information candidate list for inclusion in the second list of motion information candidates for the AMVP mode comprise instructions that cause the one or more processors to identify a first N motion information candidates according to an order of the motion information candidates in the merge mode list.

54. The computer-readable storage medium of claim 52, further comprising instructions that cause the one or more processors to scale one or more of the motion information candidates identified from the merge mode motion information candidate list for inclusion the second list of motion information candidates for the AMVP mode based on a difference between a reference picture picture order count (POC) specified by a reference picture index of the identified motion information candidate and a reference picture POC specified by a reference picture index signaled for coding the second video block using the AMVP mode.

55. The computer-readable storage medium of claim 54, wherein the instructions that cause the one or more processors to scale one of more of the motion information candidates identified from the merge mode motion information candidate list for inclusion the second list of motion information candidates for the AMVP mode comprise instructions that cause the one or more processors to:
if the reference picture index and a reference picture list of the identified motion information candidate are the same as a reference picture list and a reference picture index signaled for coding the second video block using the AMVP mode, include the identified motion information candidate in the second list of motion information candidates without scaling the identified motion information candidate;
if the reference picture list of the identified motion information candidate is different than the reference picture list signaled for coding the second video block using the AMVP mode, but the reference picture POC specified by the reference picture index of the identified motion information candidate is the same as the reference picture POC specified by the reference picture index signaled for the AMVP mode, include the identified motion information candidate in the second list of motion information candidates without scaling the identified motion information candidate; and
otherwise scale the identified candidate based on the difference between the reference picture POC specified by the reference index of the identified motion information candidate and the reference picture POC specified by the reference picture index signaled for coding the second video block using the AMVP mode.

56. The computer-readable storage medium of claim 52, wherein the instructions that cause the one or more processors to identify motion information candidates from the merge mode motion information candidate list for inclusion in the second list of motion information candidates for the AMVP mode comprise instructions that cause the one or more processors to identify motion information candidates in the merge mode list having a reference picture list and a reference picture index that are the same as a reference picture list and a reference picture index signaled for coding the second video block using the AMVP mode.

57. The computer-readable storage medium of claim 56, wherein the instructions that cause the one or more processors to identify motion information candidates from the merge mode motion information candidate list for inclusion in the second list of motion information candidates for the AMVP mode further comprises instructions that cause the one or more processors to:
if a number of motion information candidates in the merge mode list having the same reference picture list and the same reference index as the reference picture list and the reference picture index signaled for coding the second video block using the AMVP mode is less than a maximum number of candidates for the second list of motion information candidates for the AMVP mode, identify motion information candidates in the merge mode list having a different reference picture list than the reference picture list signaled for coding the second video block using the AMVP mode, but whose reference picture index specifies a reference picture picture order count (POC) that is the same as a reference picture POC specified by the reference picture index signaled for coding the second video block using the AMVP mode.

58. The computer-readable storage medium of claim 57, wherein the instructions that cause the one or more processors to identify motion information candidates from the merge mode motion information candidate list for inclusion in the second list of motion information candidates for the AMVP mode further comprise instructions that cause the one or more processors to:
if a number of motion information candidates in the merge mode list having the same reference picture list and reference picture index as signaled for coding the second video block using the AMVP mode, or a having a different reference picture list than the reference picture list signaled for coding the second video block using the AMVP mode but whose reference picture index specifies the same reference picture POC as specified by the reference picture index signaled for coding the second video block using the AMVP mode is less than a maximum number of candidates for the second list of motion information candidates for the AMVP mode:
identify at least one motion information candidate remaining in the merge mode motion information candidate list; and
scale the identified motion information candidate based on a difference between a reference picture POC specified by the reference index of the identified motion information candidate and the reference picture POC specified by the reference picture index signaled for coding the second video block using the AMVP mode.

59. The computer-readable storage medium of claim 50, wherein the common list construction process for the first and second motion information prediction modes comprises, for each motion information candidate list constructed according to the common list construction process, a common maximum number of motion information candidates for the motion information candidate list, a common scan order for consideration of motion information of neighboring blocks, common criteria for inclusion of motion information of neighboring blocks as a motion information candidate in the motion information candidate list, and a common process for pruning the motion information candidate list.
